(19) United States
(12) Patent Application Publication
(10) Pub. No.: US 2025/0001854 A1
(43) Pub. Date: Jan. 2, 2025

(54) DRIVE ASSEMBLY

(71) Applicants: Saietta Group PLC, Upper Heyford (GB); Consolidated Metco, Inc., Vancouver, WA (US)

(72) Inventors: Adrianus Petrus Maria Jonker, Upper Heyford (GB); Gerrit Jan Kwintenberg, Upper Heyford (GB); Jonathan Elkin, Camas, WA (US); Jared Wiley Richard Burris, Ridgefield, WA (US); Bryan Williams, Camas, WA (US); Michael Miga, Portland, OR (US); Beto Dantas, Brush Prairie, WA (US)

(21) Appl. No.: 18/215,766

(22) Filed: Jun. 28, 2023

(30) Foreign Application Priority Data
Jul. 5, 2022 (GB) 2209889.1

(51) Int. Cl. B60K 7/00; B60B 11/04; B60B 21/00; B60B 27/00; B60K 11/02; B60K 17/04; B60R 16/02

(52) U.S. Cl. CPC B60K 7/0007; B60B 11/04; B60B 21/00; B60B 27/0015; B60B 27/0047; B60K 11/02; B60K 17/046; B60R 16/0207; B60B 2900/111; B60B 2900/115; B60K 2007/0092; F16H 2057/02034; F16H 2057/02043

(57) ABSTRACT

A drive assembly for a vehicle is disclosed. The drive assembly comprises a central hub having an axis of rotation; an in-wheel electrical machine comprising a stator and a rotor; and a rim assembly comprising an inward circumferential part and an outward circumferential part, said inward circumferential part and said outward circumferential part being disposed adjacent each other along said axis of rotation, each part comprising a rim section for carrying a respective tyre, wherein the rim assembly is coupled to the hub. The in-wheel electrical machine is arranged outwardly of, and coupled to, the hub. A vehicle comprising the drive assembly is also disclosed.

### CROSS-REFERENCE TO RELATED APPLICATION

This application claims priority from United Kingdom Patent Application No. 2209889.1, filed Jul. 5, 2022, which is hereby incorporated herein by reference in its entirety.

### FIELD

The present disclosure relates to a drive assembly for a vehicle. In particular, the drive assembly is for a truck, for example a flatbed truck, a box truck, a tractor truck or the like, or for an active trailer. A vehicle comprising the drive assembly is also disclosed.

### BACKGROUND

Electrical machines, including electric motors and electric generators, are widely used. However, concerns over our reliance on, and the pollution caused by, fossil fuel dependent internal combustion engines is increasing political and commercial pressures to extend the use of electrical machines to new applications, and to expand their use in existing ones. Electrical machines are increasingly being used in vehicles, such as electric cars, motorbikes, boats and aircraft. They are also used in energy generation, such as generators in wind turbines.

Another possible application of electrical machines is in trucks, such as flatbed trucks. As flatbed trucks typically have a double-wheel arrangement, their hubs differ significantly from hubs for electric cars and motorbikes. As such, in-wheel type electric machine drive assemblies for such vehicles typically require significant modification to standard hubs used for such trucks.

However, any modification to a standard hub may limit how economical integration of an in-wheel electrical machine is. As such, the inventors have appreciated the need for a drive assembly having a double rim assembly and an in-wheel electrical machine, which requires minimal or no structural modification of a standard hub, as well as minimal or no structural modification of the braking system and the axle body.

### SUMMARY OF INVENTION

Embodiments described herein provide a drive assembly for a vehicle, and a vehicle comprising a drive assembly, as defined in the appended independent claims, to which reference should now be made. Preferred or advantageous features of the disclosure are set out in the dependent sub-claims.

In a first aspect, the disclosure provides a drive assembly for a vehicle. The drive assembly comprises: a central hub having an axis of rotation; an in-wheel electrical machine comprising a stator and a rotor; and a rim assembly comprising an inward circumferential part and an outward circumferential part, said inward circumferential part and said outward circumferential part being disposed adjacent each other along said axis of rotation, each part comprising a rim section for carrying a respective tyre. The rim assembly is coupled to the hub, and the in-wheel electrical machine is arranged outwardly of, and coupled to, the hub.

Advantageously, by providing a rim assembly that is coupled to the hub, and an in-wheel electrical machine which is arranged outwardly of, and coupled to, the hub, a drive assembly having an in-wheel electrical machine may be provided in which an in-wheel electrical machine may be combined with a standard hub for a double-wheel arrangement.

As both the electric machine and the rim assembly is coupled to the hub, the hub carries the load of the vehicle, while the rotor housing does not carry (any of) the load, which allows for the non-structural rotor housing to be significantly lighter. Indeed, it allows for a standard electrical machine to be used. As such, this not only allows for a lighter electrical machine to be used, but also for the drive assembly to comprise a standard hub with little or no modification.

The terms “inward” and “outward” as used herein refer to an orientation relative to a vehicle to which a drive assembly, in use, may be coupled. In particular, inward may refer to a position which is closer to such a vehicle, whereas outward may refer to a position which is further from the vehicle. The term “vehicle side” may be used instead of “inward”, and the term “road side” may be used instead of “outward”.

The term circumferential part of the rim assembly may refer to a wheel rim configured to carry a tyre.

Optionally, the rim assembly is directly coupled to the central hub. In other words, the rim assembly is not coupled to the central hub via, or together with, the electrical machine, or via any other element, but directly to hub. This may ensure that loads on the drive assembly may be transmitted directly to the hub.

Optionally, the rim assembly is directly coupled to the central hub inwardly of the electrical machine. Advantageously, this may allow for the rim assembly to be coupled to the central (standard) hub inwardly of the electrical machine, i.e. on the same side as the electrical machine is coupled to the central hub. In this manner, the standard hub may be used without any significant modification being required to the hub.

Optionally, the rim assembly comprises a substantially planar attachment section for mounting the rim assembly to the central hub. Advantageously, a substantially planar attachment section may provide a particularly suitable structure for attachment of a rim assembly.

Optionally, the rim assembly further comprises: an inward bridge section extending between the attachment section and the rim section of the inward circumferential part, the inward bridge section extending at least partially along a first direction of the rotational axis of the hub; and an outward bridge section extending between the attachment section and the rim section of the outward circumferential part, the outward bridge section extending at least partially along a second direction of the rotational axis of the hub. Such bridge sections may advantageously connect the attachment section to the inward and outward circumferential parts.

Optionally, the inward bridge section is integral with the attachment section. Advantageously, the inward bridge section being integral with the attachment section may result in a stronger rim assembly. Indeed, it may allow for the rim assembly to be coupled to the central hub in fewer steps.

Optionally, the inward bridge section is fixedly connected with the rim section of the inward circumferential part. Advantageously, this may result in a stronger rim assembly, and may allow for the rim assembly to be coupled to the central hub in fewer steps, or in a single step.

Optionally, the outward bridge section is integral with the attachment section. Advantageously, the outward bridge section being integral with the attachment section may result in a stronger rim assembly. Indeed, it may allow for the rim assembly to be coupled to the central hub in fewer steps.

Optionally, the outward bridge section is fixedly connected with the rim section of the outward circumferential part. Advantageously, this may result in a stronger rim assembly, and may allow for the rim assembly to be coupled to the central hub in fewer steps, or in a single step.

The specific shape of the outward bridge section and inward bridge section may differ depending on the application. However, at least one of the outward bridge section and inward bridge section may comprise a curved section. This may increase the strength of the bridge section, and may allow for a thinner bridge section to be used, saving weight and material.

Optionally, the inward bridge section is integral with a first, inward, portion of the attachment section, and the outward bridge section is integral with a second, outward, portion of the attachment section. By providing an attachment section having a first, inward, portion and a second, outward, portion, which are integral with the respective bridge sections, the bridge sections may be coupled to the central hub more securely, and may be coupleable to the central hub independently from one another.

Optionally, the rim assembly is coupled to the hub by a plurality of fasteners having a pitch circle diameter, the pitch circle diameter being greater than a diameter of the in-wheel electrical machine. Advantageously, such an arrangement of diameter of the pitch circle and the in-wheel electrical machine, i.e. a relative sizing of the electrical machine relative to the rim to allow for a pitch circle diameter to be larger than the electrical machine, may facilitate easier attachment of the rim assembly to the central hub.

Indeed, such a drive assembly may allow for the largest possible motor diameter whilst still providing a standardized way of mounting a rim to a standard hub. As motor volume correlates directly with peak torque of an electric motor, allowing for the largest possible motor diameter may enable the drive assembly to provide the maximum torque possible.

Optionally, each fastener is accessible inwardly of the central hub. Alternatively, each fastener is accessible outwardly of the central hub. Advantageously, if fasteners are accessible outwardly of the central hub, the rim assembly may be easily coupled to the central hub from a road side of the drive assembly. Having the fasteners accessible inwardly of the central hub may provide a more secure coupling between the central hub and the rim assembly.

Optionally, the in-wheel electrical machine is coupled to the hub independently of the rim assembly. Advantageously, this may allow the rim assembly to be detachable from the central hub without having to remove the in-wheel electrical machine, facilitating maintenance and repair of the drive assembly and potentially also of other components of a vehicle employing the drive assembly.

Optionally, a drive assembly according to any preceding claim, wherein the in-wheel electrical machine is a direct drive in-wheel electric motor. Advantageously, a direct drive in-wheel electric motor may facilitate maintenance, reduce noise during operation, and provide higher efficiency compared to an indirect electric motor.

Optionally, the drive assembly may be configured to provide a torque of at least 3,000 Nm, optionally of at least 4,000 Nm, optionally of at least 5,000 Nm, optionally up to 5,500 Nm. Such a torque may be sufficient to drive a vehicle such as a US class 6/7 truck in a 6×4 configuration. As will be appreciated, the drive assembly of the present disclosure is not limited to such torque provision, and may be adapted to provide any required torque.

Optionally, the drive assembly further comprises a gearbox. Advantageously, a gearbox allows for a torque to weight ratio of the electrical machine to be adjusted depending on a desired application, e.g. to be increased for an electric motor, or for an electric generator.

Optionally, the gearbox is a planetary gearbox. Advantageously, a planetary gearbox may be combined with an in-wheel electrical machine without significantly increase the size of the in-wheel electrical machine by attaching it to an end face of the electrical machine.

Optionally, the planetary gearbox is provided outwardly of the in-wheel electrical machine. Advantageously, in this manner, the planetary gearbox may be provided without modifying the coupling of the in-wheel electrical machine or the rim assembly to the central hub.

Optionally, the in-wheel electrical machine is an in-wheel electric motor, and the planetary gear box is configured to increase a motor speed of the electric motor relative to a wheel speed to increase a maximum torque output of the drive assembly. Advantageously, this allows for a higher torque to weight ratio to be achieved by a given electrical machine.

Optionally, the drive assembly is configured to provide a torque of at least 5,000 Nm, optionally of at least 8,000 Nm, optionally of at least 10,000 Nm, optionally of about 10,500 Nm. Such a torque may be sufficient to drive a vehicle such as a US class 8 truck using a 6×4 drive configuration. As will be appreciated, the drive assembly of the present disclosure is not limited to such torque provision, and may be adapted to provide any required torque.

Optionally, the stator is cooled by a liquid coolant. The liquid coolant optionally comprises water. The liquid coolant optionally comprises glycol. Preferably, the coolant comprises a water/glycol mixture. Advantageously, liquid cooling allows for improved removal of heat from the electrical machine, allowing for a higher current density and therefore a larger torque density.

Optionally, the drive assembly comprises tubing for providing liquid coolant to the stator through a spindle of the drive assembly attached to the central hub and a central bore of the central hub. Advantageously, such an arrangement allows for coolant to be easily supplied to the electrical machine, without modifying a standard central hub.

Optionally, the drive assembly comprises, or the drive assembly is configured to be connected to, electrical wiring routed through a, or the, spindle of the drive assembly attached to the central hub and a, or the, central bore of the central hub.

Advantageously, such an arrangement allows for required connections to and from the electrical machine of the drive assembly without modification of a standard central hub.

The electrical wiring may comprise: cables for conducting electrical power to and/or from the electrical machine, e.g. motor phase cables; and/or temperature sensors and/or wiring for temperature sensors; and/or electrical wires for an electrical machine rotational position sensor, e.g. a motor rotational position sensor; and/or electrical wires for high voltage interlock loop HVIL; and/or a grounding wire.

The drive assembly may comprise at least one temperature sensor for measuring a temperature of temperature sensitive components of the drive assembly, e.g. the electrical machine. In this way, the electrical machine may be protected from damage from overheating.

The drive assembly may comprise at least one electrical machine rotational position sensor, such as a motor rotational position sensor. Such a position sensor may allow for improved control of the electrical machine.

In a second aspect, the disclosure provides a vehicle comprising at least one drive assembly according to the first aspect.

Optionally, the vehicle is a truck. Further optionally, the vehicle is a tractor truck. Optionally, the vehicle is a flatbed truck, a box truck, or the like. In particular, the vehicle may be a US class 6/7 truck in a 6×4 configuration, or a US class 8 truck in a 6×4 configuration. Alternatively, the vehicle may be an active trailer.

It will be appreciated that features described in relation to one aspect of the present disclosure may also be applied equally to all of the other aspects of the present disclosure. Features described in relation to the first aspect of the present disclosure may be applied equally to the second aspect of the present disclosure and vice versa. For example, features of the drive assembly described in relation to the first aspects may be applied, mutatis mutandis, to the vehicle of the second aspect.

It will further be appreciated that particular combinations of the various features described and defined in any aspects of the invention may be implemented and/or supplied and/or used independently.

### BRIEF DESCRIPTION OF THE DRAWINGS

Specific embodiments of the invention will now be described with reference to the figures, in which:

FIG. 1 shows a perspective view of a drive assembly according to the disclosure;

FIG. 2 shows a perspective cross-sectional view of the drive assembly of FIG. 1;

FIG. 3 shows a further perspective cross-sectional view of the drive assembly of FIGS. 1 and 2;

FIG. 4 shows a cross-sectional view of a portion of a further drive assembly according to the disclosure; and

FIG. 5 shows a further cross-sectional view of the further drive assembly according to FIG. 4.

### DETAILED DESCRIPTION

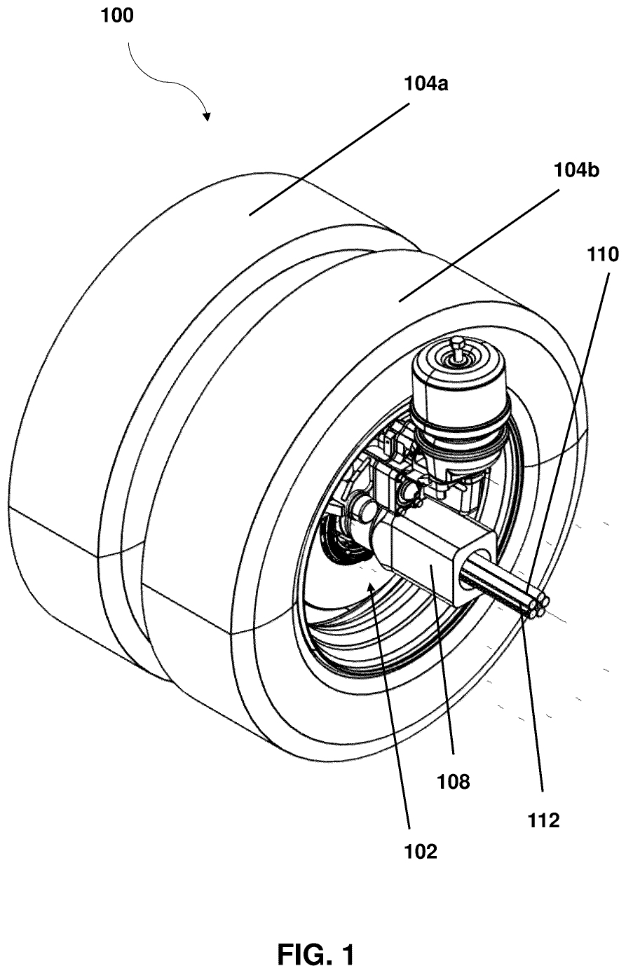

FIG. 1 illustrates an example system 100 including a drive assembly 102 for a truck, in particular a flatbed truck, to which two tyres 104a, 104b are attached.

Attached to the drive assembly 102 is a spindle 108 through which tubing 112 for a liquid coolant and electrical wiring 110 extend.

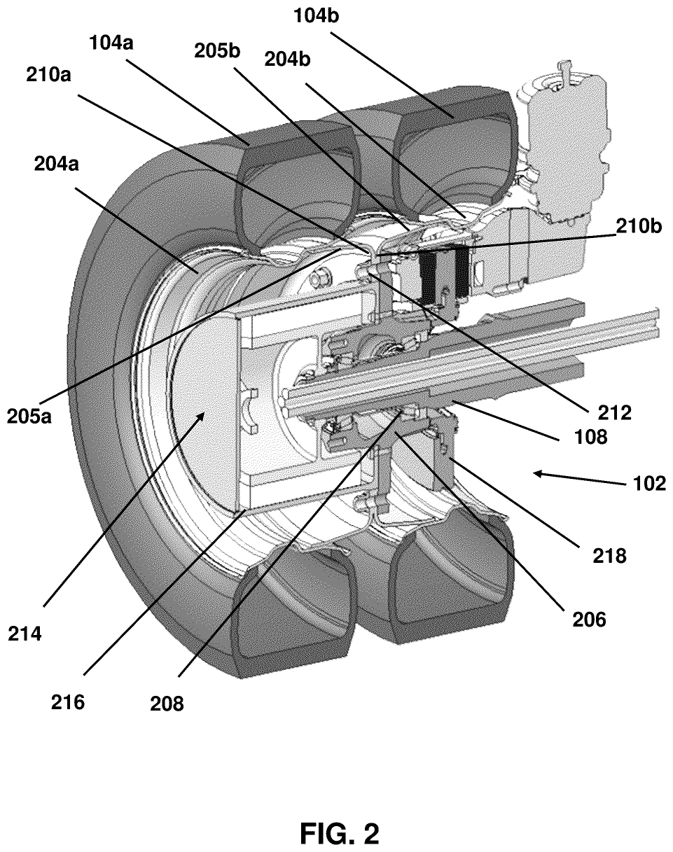

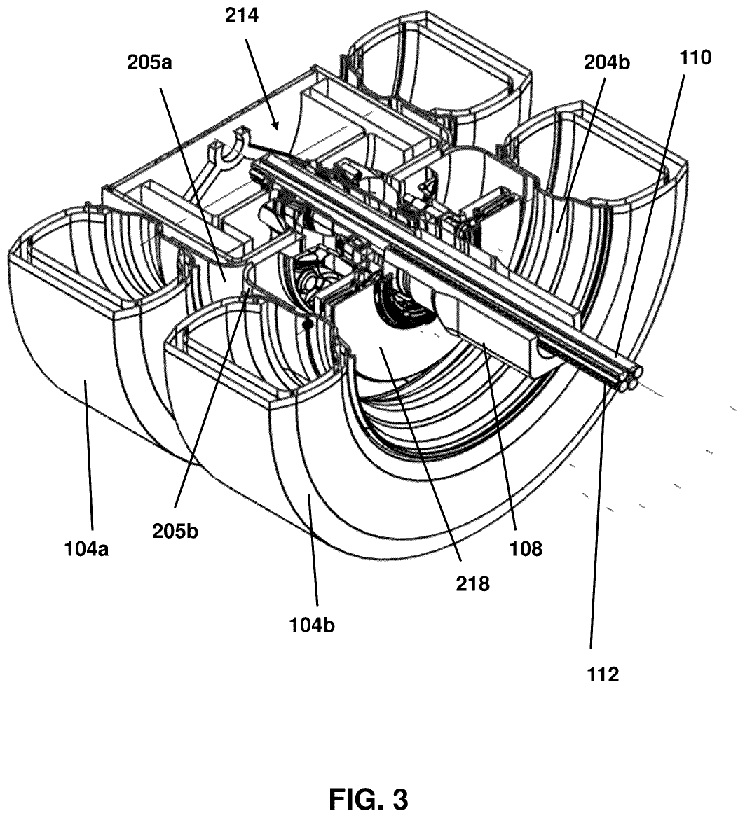

As shown in FIGS. 2 and 3, the road-side, or outwardly, tyre 104a is carried by an outward circumferential rim 204a and the vehicle-side, or inwardly, tyre 104b is carried by an inward circumferential rim section 204b. Respective bridge sections 205a, 205b, attach the circumferential rim sections 204a, 204b to a central hub 206 of the drive assembly 102.

The central hub 206 has a central cavity 208. The central hub 206 is a standardized hub for a flatbed truck, which forms part of the drive assembly 102. The spindle 108 extends through the central cavity 208 so that the tubing 112 and the electrical wiring 110 extend from a vehicle side to a road-side, or outward side, of the central hub 206.

Formed as a single part with each of the respective bridge sections 205a, 205b are respective, substantially planar, attachment sections 210a, 210b. The attachment sections 210a, 210b are attached to the central hub 206 by fasteners 212 arranged around a rim pitch circle diameter.

Also attached to the central hub 206 is an electrical machine, in this case an electric motor 214. The electric motor 214 is arranged on a road-side of, i.e. outwardly of, the central hub 206. As the tubing 112 and the electrical wiring 110 extend to a road-side of the central hub 206, they provide liquid coolant (a water/glycol mixture) and electrical power to the electric motor 214, but also temperature sensors (and/or electrical power for temperature sensors) and electrical wires for a motor rotational position sensor, electrical wires for high voltage interlock loop HVIL, and a grounding wire for grounding the metal components of the electric motor.

The relative diameter of the electric motor 214, the pitch circle diameter of the fasteners 212 and the circumferential rim sections 204a, 204b are selected such that the fasteners 212 can be fastened to attach the rims to the central hub 206 from a road-side.

The electric motor 214 comprises an external housing 216, or rotor housing. As is clear from FIGS. 1 to 3, the external housing 216 is relatively thin. This is made possible by the load of the vehicle being carried by the central hub 206, and not, as is commonly the case in the prior art, by the rotor housing 216 of the electric motor 214.

As best seen in FIG. 3, the drive assembly 102 further comprises a standard brake disc 218, requiring no or minimal modification to function in the drive assembly 102 comprising the electric motor 214.

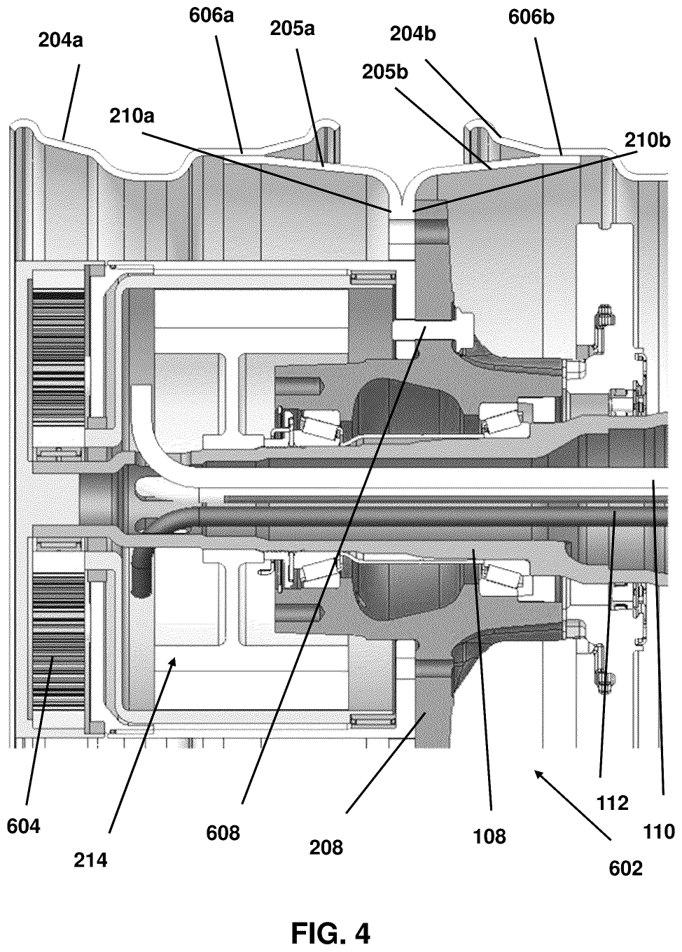

FIG. 4 shows a further example of a drive assembly 602. The drive assembly comprises an electric motor 214. In contrast to the drive assembly 102 of FIGS. 1 to 3, the electric motor 214 of drive assembly 602 comprises a planetary gearbox 604. The planetary gearbox 604 is configured to increase the torque produced by the electric motor 214, which may allow a smaller electric motor to be used in the drive assembly 602.

The drive assembly 602 also comprises a spindle 108 through which tubing 112 for a liquid coolant and electrical wiring 110 extend. The central hub 206 also has a central cavity 208, and is a standardized hub for a flatbed truck, which forms part of the drive assembly 602. The spindle 108 extends through the central cavity 208 so that the tubing 112 and the electrical wiring 110 extend from a vehicle side to a road-side, or outward side, of the central hub 206.

In the drive assembly 602, the spindle 108, the tubing 112 and electrical wiring 110 extend centrally through the electric motor 214 so as to provide electrical power and cooling to the electric motor 214 but also a mechanical coupling to the planetary gearbox 604, which is arranged outwardly, i.e. road-side, of the electric motor 214.

The rim assembly of drive assembly 602 is very similar, or identical, to the rim assembly of drive assembly 102.

In particular, a road-side, or outward, circumferential rim 204a carries an outward tyre 104a, and the vehicle-side, or inward, circumferential rim section 204b (only partly shown) carries an inward tyre 104b. Respective bridge sections 205a, 205b, attach the circumferential rim sections 204a, 204b to a central hub 206 of the drive assembly 102.

As best seen in FIG. 4, the bridge sections 205a, 205b are attached fixedly to the respective circumferential rim sections 204a, 204b along respective interfaces 606a, 606b. The fixed attachment may be by welding, or by any other suitable means.

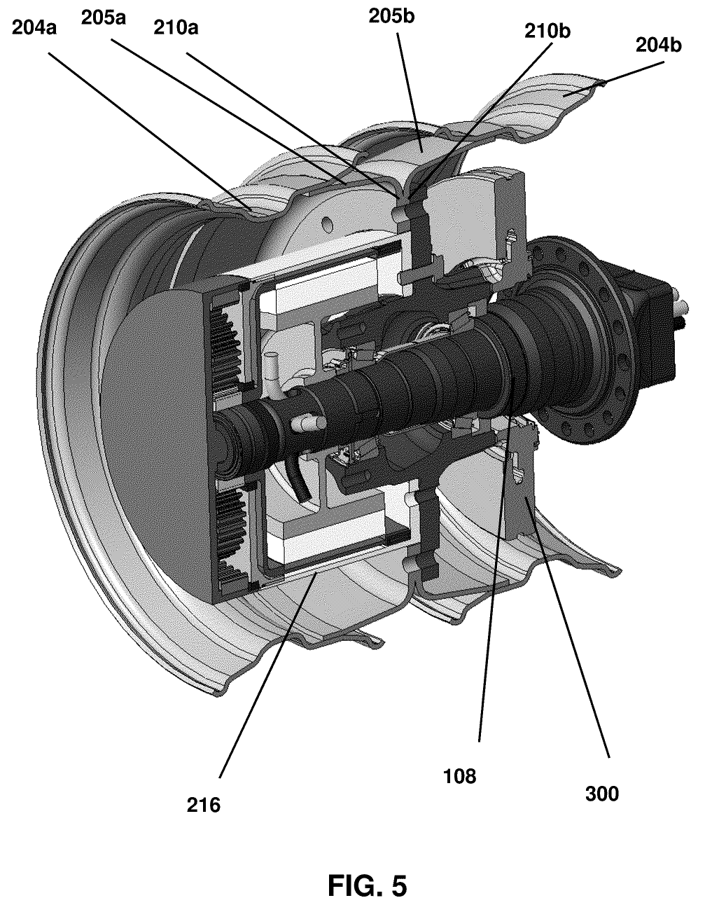

Formed as a single part with each of the respective bridge sections 205a, 205b are respective, substantially planar, attachment sections 210a, 210b. The attachment sections 210a, 210b are attached to the central hub 206 by fasteners (not shown in FIG. 4 or 5) arranged around a rim pitch circle diameter.

The relative diameter of the electric motor 214, the pitch circle diameter of the fasteners and the circumferential rim sections 204a, 204b are selected such that the fasteners can be fastened to attach the rims to the central hub 206 from a road-side.

As best seen in FIGS. 4 and 5, the electric motor 214 is attached to the central hub 206 by separate fasteners 608 (to those fasteners attaching the rim assembly to the central hub 206). These fasteners 608 are accessible from a vehicle side of the drive assembly 602. A housing or casing of the motor may comprise threaded apertures for receiving the fasteners. Alternatively, the fasteners 608 may comprise nuts within the electric motor 214 (not shown).

As discussed above in relation to the drive assembly 102, the electric motor 214 of drive assembly 602 comprises an external housing 216, or rotor housing. The external housing 216 of the drive assembly is relatively thin, which is made possible by the central hub 206 carrying the load of the vehicle, and not the rotor housing 216.

The drive assembly 602 further comprises a standard brake disc 218, requiring no or minimal modification to function in the drive assembly 102 comprising the geared electric motor 214.

1. A drive assembly for a vehicle, the drive assembly comprising:
a central hub having an axis of rotation;
an in-wheel electrical machine comprising a stator and a rotor; and
a rim assembly comprising an inward circumferential part and an outward circumferential part, said inward circumferential part and said outward circumferential part being disposed adjacent each other along said axis of rotation, each part comprising a rim section for carrying a respective tyre,
wherein the rim assembly is coupled to the hub, and
wherein the in-wheel electrical machine is arranged outwardly of, and coupled to, the hub.

2. The drive assembly of claim 1, wherein the rim assembly is directly coupled to the central hub.

3. The drive assembly of claim 2, wherein the rim assembly is directly coupled to the central hub inwardly of the electrical machine.

4. The drive assembly of claim 2, wherein the rim assembly comprises a substantially planar attachment section for mounting the rim assembly to the central hub.

5. The drive assembly of claim 4, wherein the rim assembly further comprises:
an inward bridge section extending between the attachment section and the rim section of the inward circumferential part, the inward bridge section extending at least partially along a first direction of the rotational axis of the hub; and
an outward bridge section extending between the attachment section and the rim section of the outward circumferential part, the outward bridge section extending at least partially along a second direction of the rotational axis of the hub.

6. The drive assembly of claim 5, wherein the inward bridge section is integral with the attachment section.

7. The drive assembly of claim 6, wherein the inward bridge section is fixedly connected with the rim section of the inward circumferential part.

8. The drive assembly of claim 5, wherein the outward bridge section is integral with the attachment section.

9. The drive assembly according to of claim 8, wherein the outward bridge section is fixedly connected with the rim section of the outward circumferential part.

10. The drive assembly any of claim 5, wherein the inward bridge section is integral with a first, inward, portion of the attachment section, and the outward bridge section is integral with a second, outward, portion of the attachment section.

11. The drive assembly of claim 1, wherein the rim assembly is coupled to the hub by a plurality of fasteners having a pitch circle diameter, the pitch circle diameter being greater than a diameter of the in-wheel electrical machine.

12. The drive assembly of claim 11, wherein each fastener is accessible inwardly of the central hub or wherein each fastener is accessible outwardly of the central hub.

13. The drive assembly of claim 1, wherein the in-wheel electrical machine is coupled to the hub independently of the rim assembly.

14. The drive assembly of claim 1, wherein the in-wheel electrical machine is a direct drive in-wheel electric motor.

15. The drive assembly of claim 14, configured to provide a torque of at least 3,000 Nm.

16. The drive assembly of claim 1, comprising a gearbox.

17. The drive assembly of claim 16, wherein the gearbox is a planetary gearbox.

18. The drive assembly of claim 17, wherein the planetary gearbox is provided outwardly of the in-wheel electrical machine.

19. The drive assembly of claim 17, wherein the in-wheel electrical machine is an in-wheel electric motor, and wherein the planetary gear box is configured to increase a motor speed of the electric motor relative to a wheel speed to increase a maximum torque output of the drive assembly.

20. The drive assembly of claim 17, wherein the drive assembly is configured to provide a torque of at least 5,000 Nm.

21. The drive assembly of claim 1, wherein the stator is cooled by a liquid coolant, optionally the liquid coolant comprises at least one of water and glycol.

22. The drive assembly of claim 21, comprising, or configured to be connected to, tubing for providing liquid coolant to the stator through a spindle of the drive assembly attached to the central hub and a central bore of the central hub.

23. The drive assembly of claim 1, further comprising, or configured to be connected to, electrical wiring routed through a, or the, spindle of the drive assembly attached to the central hub and a central bore of the central hub.

24. The drive assembly of claim 23, wherein the electrical wiring comprises at least one of:
at least one cable for conducting electrical power to and/or from the electrical machine; and
at least one temperature sensor and/or wiring for at least one temperature sensor; and
electrical wires for an electrical machine rotational position sensor; and
electrical wires for high voltage interlock loop; and
a grounding wire.

25. A vehicle comprising at least one drive assembly of claim 1.
